(19) United States
(12) Patent Application Publication
(10) Pub. No.: US 2006/0251344 A1
(43) Pub. Date: Nov. 9, 2006

(54) Device comprising a floating bearing system and guide track consisting of tiles

(76) Inventor: Karl Weis, Frammersbach (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/560,698

(22) PCT Filed: Jun. 11, 2004
(86) PCT No.: PCT/DE04/01194

§ 371 Date: May 12, 2006

(30) Foreign Application Priority Data
Jun. 11, 2003 (DE) 103267123

(51) Int. Cl. F16C 32/06

(52) U.S. Cl. 384/12

(57) ABSTRACT

This invention relates to a device (01) having at least two components (09, 10) that are movable in relation to one another, whereby at least one aircushion bearing element (14) is provided on the first component (10) and cooperates with a guideway (15) provided on the second component (09) such that the first component (10) is guided and/or supported on the second component without contact with an air gap between the aircushion bearing element (14) and the guideway (15). The guideway (15) is made of tiles (20) which are attached side-by-side to the second component (09).

The present invention relates to a device having an aircushion bearing between two components that are movable toward one another according to the preamble of claim 1.

Generic devices with aircushion bearings are used as measuring machines, for example, but by no means exclusively. The aircushion bearing allows a high-precision guidance of the components that are movable relative to one another. Because of the non-contact bearing, there is also no surface friction in the bearing elements. The air gap between the aircushion bearing element itself and the guideway situated opposite is usually in the range of 3 μm to 10 μm.

This small gap width between the aircushion bearing element and the guideway requires a very high manufacturing quality, while maintaining very low manufacturing tolerances. The requirements of these guideways regarding their flatness and peak-to-valley height in particular are also extremely high. To allow the manufacture of such high-precision guideways, it is therefore known from the state of the art that materials such as natural hard rock, especially granite, should be used.

German Patent DE 101 40 174 A1, for example, describes a coordinate measuring machine in which all the components having guideways are made of granite. The guideways are cut in the block of natural rock by suitable machining operations, e.g., grinding and lapping.

One disadvantage of this type of manufacturing procedure is that there are some major drawbacks to using natural hard rock as the starting material. For example, granite blocks of a suitable size and quantity must be imported from third world countries because such materials are not available in Central Europe. Machining of natural hard rock is extremely complex and time intensive. Furthermore, natural hard rock can be processed only as solid material in blocks, which greatly limits the design options and in particular the size of the components to be produced.

Therefore, against the background of this state of the art, the object of the present invention is to propose a novel device having an aircushion bearing that will avoid the disadvantages of the state of the art known in the past.

This object is achieved by a device according to the teaching of claim 1.

Advantageous embodiments of this invention are the object of the dependent claims.

The inventive device is based on the fundamental idea that the guideways of the aircushion bearing are no longer made of a solid material such as granite, but instead tiles of a suitable material are attached side-by-side to a component which functions as a carrier to form the guideway. One advantage of this type of design is in particular the fact that the component supporting the guideway itself can be constructed independently of the material of the guideway and therefore may be designed as a steel structure, for example. Furthermore, the dimensions of the guideway, in particular its maximum length, are no longer limited by the maximum length of the supporting element, as is the case with components made of natural hard rock, for example. Instead the guideway may be designed ultimately to be of any desired length by adding additional tiles. As a result, a very broad range of design options are available to the design engineer in designing generic devices.

Ultimately it does not matter which material is selected to manufacture the tiles forming the guideway and it depends only on the corresponding material having an adequate surface quality. For example, it is quite conceivable for the tiles to be made of suitably surface-hardened metals or granite. Ceramic materials have proven to be especially suitable for producing the tiles forming the guideway. In particular the ceramic material known as Stettalit (ceramic number: C221 according to VDE 0335, Part 3) is an excellent material for forming the guideways. Stettalit is known as a starting material from mass-produced products such as heat-resistant switches in electric kitchen stoves and housing fuses and therefore is available at extremely favorable prices. Because of its material properties (open porosity: 0 vol %, density: 2.78 kg/dm³, flexural strength: approximately 140 MPa, hardness: 5 according to Moh's scale), high-precision guideways can be manufactured from this material. Stettalit can also be machined well using standard tools, is easy on tools and is therefore inexpensive to manufacture.

Essentially it does not matter how the tiles are attached to the corresponding component of the device. For example, suitable mechanical fastening techniques, especially clamping rails, may be used. Since the tiles, which are made of ceramics, for example, and the supporting element, which is produced as a steel structure, for example, have completely different physical properties, an adhesive joint in particular is suitable for fastening the tiles to the component.

The adhesive should have the lowest possible flow capacity in order to be able to join the tiles and the supporting element permanently and accurately together despite the difference in expansion coefficients.

Two-component construction adhesives have proven to be especially suitable for use as adhesives in producing the required adhesive joint. These adhesives are characterized by a very low flow capacity and a very high shear strength, impact strength and peel strength over a very wide temperature range. The company 3M, for example, offers an especially suitable two-component construction adhesive of this type under the brand name Scotch-Weld 9323B/A.

To be able to produce an adhesive joint having the highest possible strength, it is particularly advantageous if the adhesive surface of the supporting element is machined at the surface in a suitable manner before applying the adhesive, e.g., by milling off the corresponding adhesive surface, so the adhesive surface has a peak-to-valley height of approximately 50 μm to 100 μm.

The use of tiles according to the present invention in the manufacture of the guideway of the aircushion bearings has resulted in the fact that there is a transitional area between adjacent tiles. With suitable high-precision production and installation of the tiles, this transitional area may ultimately be created so that the size of the resulting joints does not interfere with the functioning of the aircushion bearings. However, it is extremely difficult to produce and install the tiles on the supporting element in such a high-precision manner. According to a preferred embodiment, a hardenable filler material is therefore provided in the transitional area between adjacent tiles. In manufacturing the guideway, the tiles are thus first secured on the supporting element, e.g., by gluing permanently, and then the joints between the adjacent tiles are filled with the unhardened filler material. After the filler material has hardened, it can be machined at the surface together with the tile material to thereby produce a guideway having an adequate surface quality, in particular adequate flatness. Grinding and lapping have proven to be especially suitable as machining methods for surface machining of tiles and/or filler material.

The peak-to-valley height of the guideway should preferably amount to less than or equal to 1 μm. The flatness of the guideway should preferably have a deviation of less than or equal to 2 μm for a distance of 200 mm.

To produce the supporting structure of the second component supporting the guideway, ultimately all these materials may be selected from any materials which have a sufficient stiffness and stability and can be attached permanently to the tiles forming the guideway in a suitable manner. In particular, welded structures of steel parts have proven especially suitable for producing the second component supporting the guideway. Such steel structures are extremely inexpensive to manufacture and in particular can be manufactured in a relatively short period of time and without any major tool costs, in particular without any tool and die costs. Furthermore, steel structures allow the design engineer to utilize a multitude of different construction approaches. The steel structure must be optimized with regard to adequate stiffness, design stability under changes in temperature and adequate dynamic strength in accordance with the desired use of the device, e.g., as a measuring machine.

The steel parts for producing the welded structure are therefore preferably produced by laser cutting (tailored planks). By laser cutting, the steel material is exposed to only relatively minor thermal stresses and therefore has only relatively minor deformational stresses.

Laser welding should preferably be used as the welding technique for joining the various steel parts. High-precision welded joints can be produced by laser welding, and again the steel parts are exposed to only relatively minor thermal stresses.

To further reduce the deformation of the second component supporting the guideway after welding due to deformational stresses, according to a preferred embodiment low-stress annealing may be performed on the second component after welding.

After welding and/or annealing the second component, a surface treatment may preferably also be performed on the steel structure. By sandblasting or some similar method, the steel structure can be freed of scale and other unwanted substances adhering to it. Furthermore, a corrosion-resistant surface may be applied, e.g., by chrome plating.

To be able to pre-assemble the steel parts to fit accurately with the least possible effort before welding, it is especially advantageous to provide tongue-and-groove elements on the steel parts. The steel parts can then be assembled with an accurate fit before welding by means of these tongue-and-groove elements.

Essentially it does not matter which design is used for the inventive device having an aircushion bearing. However, especially great advantages are achieved with the inventive construction of the guideways of the aircushion bearing in measuring machines, especially in coordinate measuring machines. Such measuring machines have at least one measuring head, which is movably mounted on the machine and can be adjusted by remote control by means of suitable drive elements. The measuring head is suitable for measuring workpieces and has measurement means suitable for doing so.

According to a preferred embodiment, the measuring machine is designed in the manner of a portal machine having at least two vertical connections and a horizontal crossbeam. Such portal measuring machines could be manufactured in the past with relatively small dimensions because the required components were not available in a sufficient size because of the natural materials being used. Through the use of the inventive design principle, measuring machines and especially portal measuring machines can now be produced ultimately in any desired size.

An embodiment of an inventive device is diagrammed schematically in the drawings and is explained in greater detail below as an example.

The drawings show:

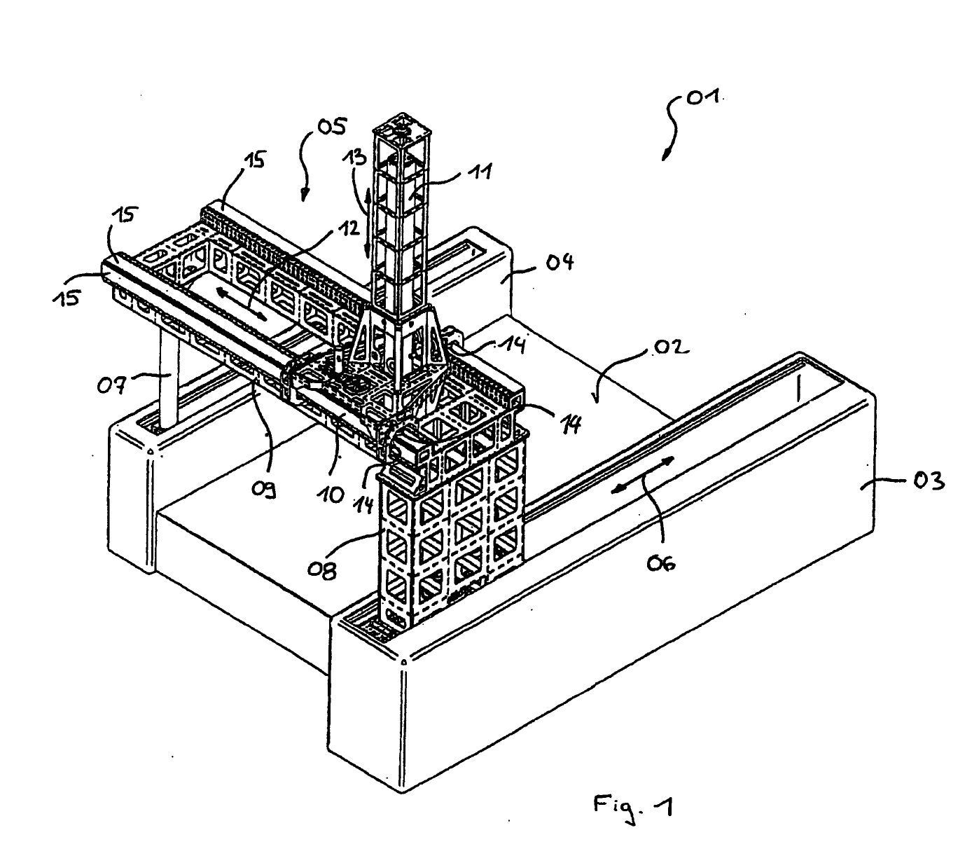

FIG. 1 a perspective view of a device designed in the manner of a measuring machine;

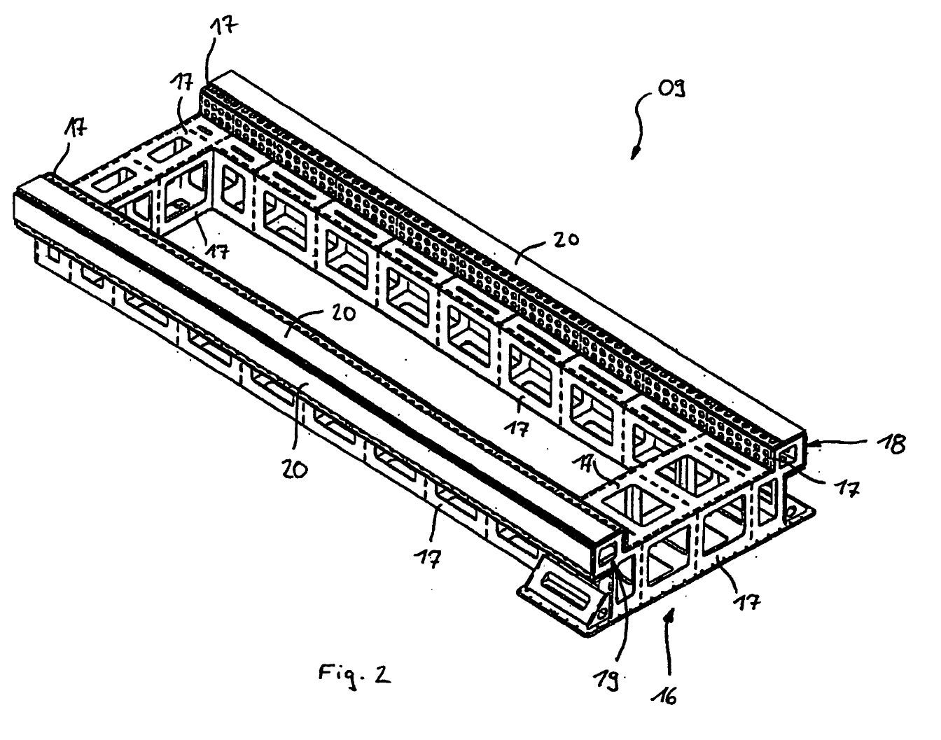

FIG. 2 a perspective view of the horizontal crossbeam of the measuring machine according to FIG. 1;

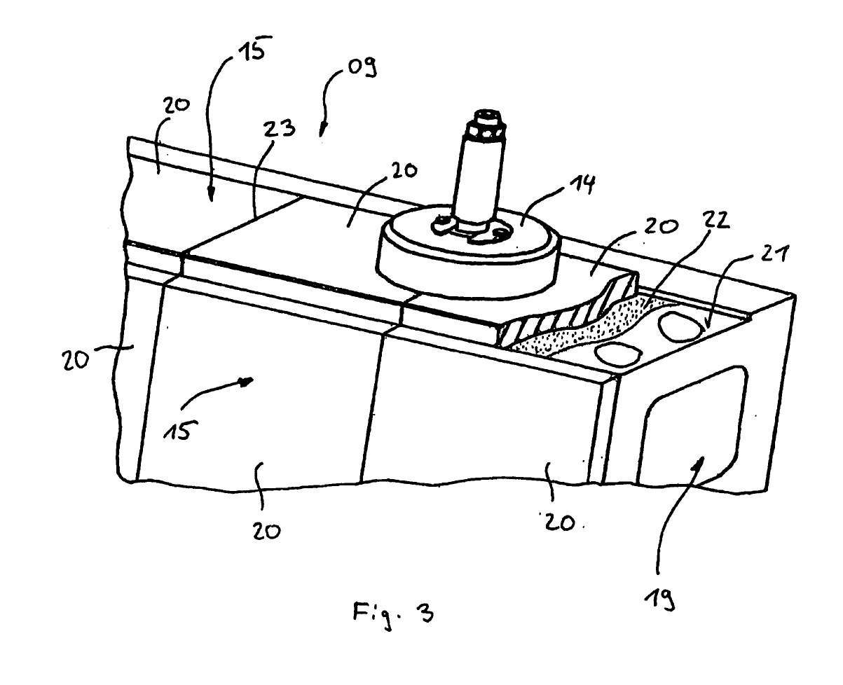

FIG. 3 the design of the guideways of the air bearing on the horizontal crossbeam according to FIG. 2 in a perspective view.

FIG. 1 shows a perspective view of an inventive device 01 designed in the manner of a coordinate measuring machine. The measuring machine 01 has a standing surface 02 on which the workpiece to be measured is situated and which can be made of a granite block, for example. As an alternative to this, the standing surface 02 may also be formed by a steel construction part equipped with ceramic tiles. Two bearing and drive devices 03 and 04 are arranged at the side of the standing surface 02 with the actual function elements of the bearing and drive devices 03 and 04 being covered by a housing. A portal 05 is supported in the bearing and drive devices 03 and 04 and can be moved horizontally over the standing surface 02 by means of suitable drive means according to the movement arrow 06.

The portal 05 is made of two vertical connections 07 and 08 and a horizontal crossbeam 09. A carriage 10 is supported on the topside of the horizontal crossbeam 09 with a vertical spindle sleeve 11 attached to the carriage. A measuring head of the measuring machine 01 is attached to the underside of the vertical spindle sleeve 11; a workpiece situated on the standing surface 02 can be measured by this measuring head. The carriage 10 can be moved horizontally according to the movement arrow 12 over the standing surface 02 on the horizontal crossbeam 09 by means of drive means (not shown in detail here). By inserting and retracting the vertical spindle sleeve 11, the measuring head can be moved vertically according to the movement arrow 13. As a result, the measuring head can also be positioned freely by moving the portal 05 and the carriage 10 in a horizontal plane and it can be positioned in height by extracting and retracting the vertical spindle sleeve 11. Therefore, the measuring head can ultimately approach all points in the space defined by the size of the standing surface 02 and the cross section of the portal 05.

For supporting the parts of the measuring machine 01 that are movable in relation to one another, aircushion bearing elements 14 are provided; these elements cooperate with the corresponding guideways 15 for non-contact bearing and guidance of the components that are movable in relation to one another. Compressed air flows at a suitable air pressure along the circular ring-shaped underside of the aircushion bearing elements 14 (see FIG. 3) and ensures that the aircushion bearing elements 14 are suspended over the guideways 15 with an air gap of a few micrometers. The movable components of the measuring machine 01 are guided and supported in a non-contact manner in this way.

The design of the horizontal crossbeam 09 is shown on an enlarged scale in FIG. 2. The horizontal crossbeam 09 gains its mechanical strength from a welded construction component 16 which is manufactured by laser welding several steel parts 17 that are manufactured by laser cutting. Each of the steel parts 17 has a tongue-and-groove connection to allow pre-assembling of the steel parts 17 by joining them together prior to laser welding.

To obtain the least possible temperature deformation, the welding construction component 16 has a plurality of recesses in the steel parts 17.

To form the guideways 15, the component 16 has two prismatic guide beams 18 and 19 on the top side, ceramic tiles 20 being cemented onto the respective outside and the respective top side (see FIG. 3) to form the guideways 15. The guideways 15 on the guide beams 18 and 19 are each aligned at right angles to one another, so that as a result the carriage 10 the carriage 10 can be guided both horizontally and vertically with precision.

The design of the guideways 15 is shown again in FIG. 3 on an enlarged scale. An adhesive 22 is applied to the adhesive surfaces 21 of the welded construction component 16 for mounting the ceramic tiles 20 and then the tiles 20 are cemented onto the layer formed by the adhesive 22. After hardening of the adhesive 22, the transitional areas 23 between neighboring tiles 20 are filled with a hardenable filler material. After hardening of the filler material, the tiles and the filler material are machined at the surface by suitable finishing methods, e.g., grinding and lapping along the guideways 15 to establish the required peak-to-valley height and flatness.

1. A device (01) having at least two components (09, 10) that are movable in relation to one another, at least one aircushion bearing element (14) being provided on the first component (10), so that it cooperates with a guideway (15) provided on the second component (09), such that the first component (10) is guided and/or supported on the second component in a non-contact manner with an air gap between the aircushion bearing element (14) and the guideway (15), characterized in that the guideway (15) is made of tiles (20) which are attached to the second component (09) side-by-side.

2. The device according to claim 1, characterized in that the tiles (20) are made of a ceramic material, in particular Stettalit having ceramic number C221 according to VDE 0335 part 3.

3. The device according to claim 1, characterized in that the tiles (20) are attached to an adhesive surface (21) of the second component (09) using an adhesive (22).

4. The device according to claim 3, characterized in that the adhesive (22) has a low flow capacity.

5. The device according to claim 3, characterized in that a two-component construction adhesive is used as the adhesive (22).

6. The device according to claim 3, characterized in that the adhesive surface (21) of the second component (09) has a peak-to-valley height of approximately 50 μm to 100 μm before applying the adhesive (22).

7. The device according to claim 1, characterized in that a hardenable filler material is provided in the transitional area (23) between adjacent tiles (20).

8. The device according to claim 1, characterized in that the areas of the tiles (20) and/or filler material forming the guideway (15) are machined at the surface, in particular by grinding and/or lapping after hardening of the adhesive and/or filler material.

9. The device according to claim 1, characterized in that the guideway (15) has a peak-to-valley height of less than or equal to 1 μm.

10. The device according to claim 1, characterized in that the guideway (15) has a flatness of less than or equal to 2 μm/200 mm.

11. The device according to claim 1, characterized in that the second component (09) is manufactured as a welded construction of multiple steel parts (17).

12. The device according to claim 11, characterized in that the steel parts (17) are produced by laser cutting.

13. The device according to claim 11, characterized in that the steel parts (17) are joined together by laser welding.

14. The device according to claim 11, characterized in that low-stress annealing is performed on the second component (09) after welding the steel parts (17).

15. The device according to claim 11, characterized in that the second component (09) is treated at the surface, in particular by sandblasting and/or with a corrosion-resistant coating, after welding or after annealing.

16. The device according to claim 11, characterized in that tongue-and-groove elements are provided for pre-assembly on the steel parts (17) to be joined together.

17. The device according to claim 1, characterized in that the device (01) is designed in the manner of a measuring machine, in particular a coordinate measuring machine having a movably mounted measurement head for measuring workpieces.

18. The device according to claim 17, characterized in that the measuring machine (01) has at least two vertical connections (07, 08) and one horizontal crossbeam (09) supported on the vertical connections (07, 08) whereby the vertical connections (07, 08) together with the horizontal crossbeam (09) form a portal (05) above a standing surface (02) on which the workpiece to be measured can be arranged.

19. The device according to claim 18, characterized in that the vertical connections (07, 08) have a vertical length in the range of approximately 0.5 meter to 5 meters, in particular 1.2 meter.

20. The device according to claim 18, characterized in that the horizontal crossbeam (09) has a horizontal span between the vertical crossbeams in the range of approximately 0.5 meter to 5 meters, especially 1.5 meter.
